(19) United States
(12) Patent Application Publication
(10) Pub. No.: US 2010/0011914 A1
(43) Pub. Date: Jan. 21, 2010

(54) HAND TOOL

(76) Inventor: CHANG MING-CHI, Taichung City (TW)

Correspondence Address: Chien-Hui Su, P. O. Box 70-121 Taichung, Taichung City, 40899, TW

(21) Appl. No.: 12/174,602

(22) Filed: Jul. 16, 2008

(51) Int. Cl. B25B 13/46; B25B 13/16

(52) U.S. Cl. 81/60; 81/155

(57) ABSTRACT

A hand tool includes a shank. A first working head is formed on a first end of the shank and has a fixed jaw extending therefrom, a movable jaw partially mounted therein, and a worm gear rotatably mounted therein. A second working head is formed on a second end of the shank. A ratchet mechanism is partially mounted in the second working head and has a ratchet wheel ratchetably mounted in the second working head, a first driving portion and a second driving portion respectively longitudinally disposed on two opposite sides of the ratchet wheel.

### BACKGROUND OF THE INVENTION

1. Field of the Invention

The present invention relates to a hand tool, and more particularly to a hand tool that has a working head having two driving portions with two different standards for suiting to sockets with various standards.

2. Description of Related Art

A conventional hand tool in accordance with the prior art comprises a first end formed as an adjustable wrench and a second end formed as a ratchet wrench. The adjustable wrench has a fixed jaw integrally extending therefrom and a movable jaw adjustably mounted on the adjustable wrench to be moved relative to the fixed jaw. The ratchet wrench has a ratchet mounted therein and a ratchet hole is centrally formed in the ratchet for driving a bolt, a fastener, or a workpiece.

However, an inner diameter of the ratchet hole is immovable. The ratchet hole of the ratchet wrench only can be used to one size of the bolt, the fastener, or the workpiece. As a result, the use scope of the conventional hand tool is limited.

The present invention has arisen to mitigate and/or obviate the disadvantages of the conventional hand tool.

### SUMMARY OF THE INVENTION

The main objective of the present invention is to provide an improved hand tool that has two driving portions having two different standards for ratchetably driving various standards of workpieces.

To achieve the objective, the hand tool in accordance with the present invention comprises a shank. A first working head is formed on a first end of the shank and includes a fixed jaw extending from the first working head, a movable jaw partially mounted in the first working head and adjustably moved relative to the fixed jaw, and a worm gear rotatably mounted in the first working head to adjust a distance between the fixed jaw and the movable jaw. A second working head is formed on a second end of the shank. A ratchet mechanism partially is mounted in the second working head and including a ratchet wheel ratchetably mounted in the second working head for providing a ratchet effect, a first driving portion and a second driving portion respectively longitudinally disposed on two opposite sides of the ratchet wheel and extending from two opposite sides of the second working head for respectively adapting to be engaged to different workpieces.

The ratchet wheel is rotatably received in the hole and engaged by a pawl for ratchetably operating. A socket has a first end sleeved on the first/second driving portion and a second end sleeved on a screw when operating. A user may grasp the shank of the hand tool to ratchetably drive the screw via the socket. Therefore, the hand tool in accordance with the present invention provides two options to operate the first working head for adjustably engaging a corresponding one of different standards of workpieces, or operate the second working head for ratchetably engaging to the workpiece via the socket.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool in accordance with the present invention;

FIG. 2 is an exploded view of a second working head of the hand tool in FIG. 1;

FIG. 3 is a perspective view of the hand tool in another direction;

FIG. 3A is a side plan view of the second working head of the hand tool in FIG. 3 in partial cross-section; and

FIG. 4 is an operational view of the hand tool in FIG. 3.

### DETAILED DESCRIPTION OF THE INVENTION

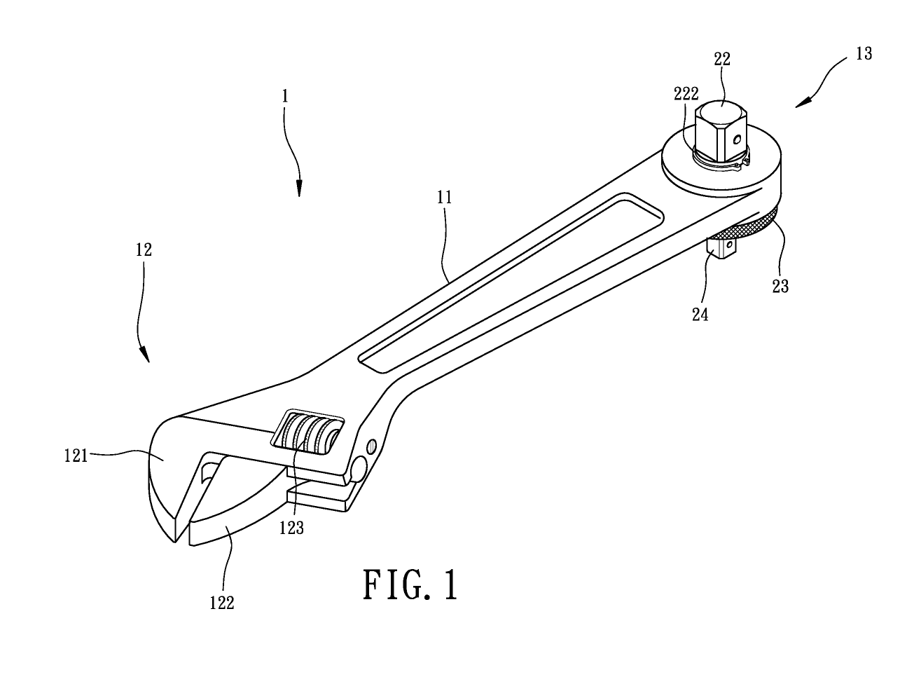

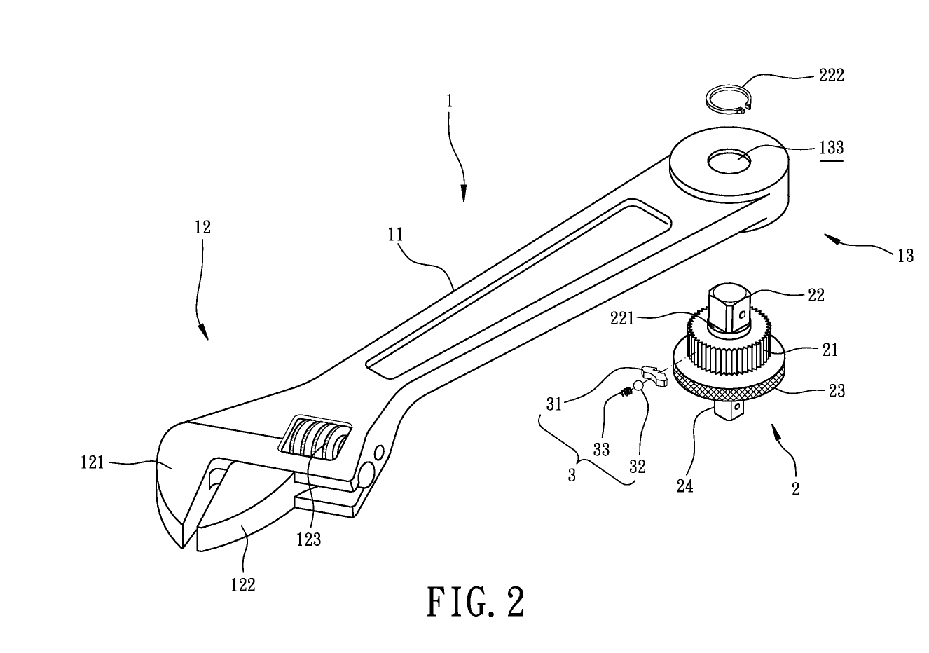

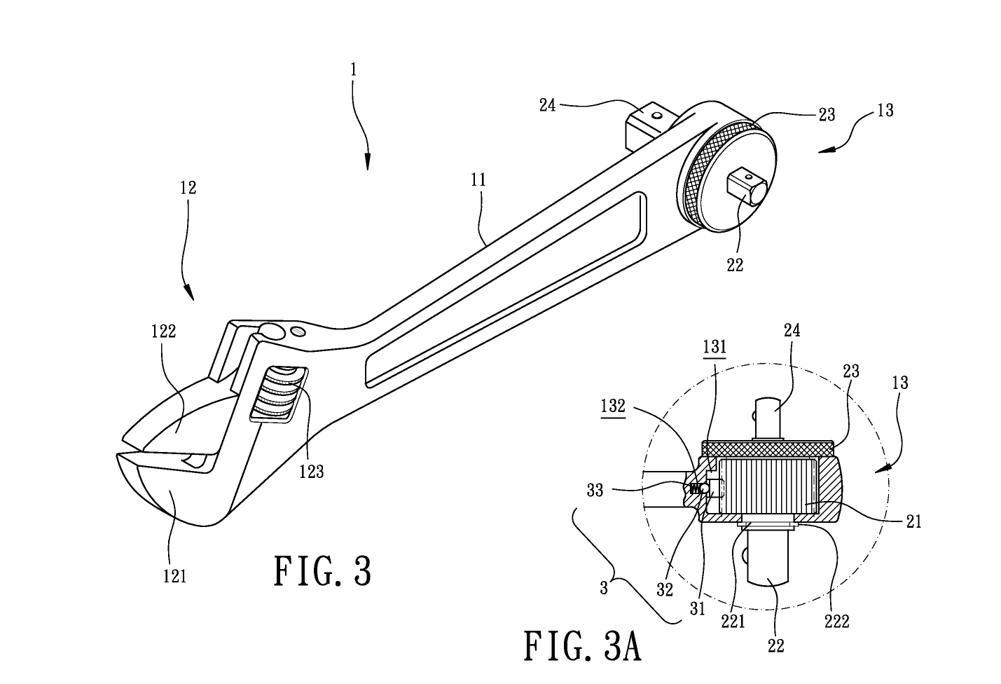

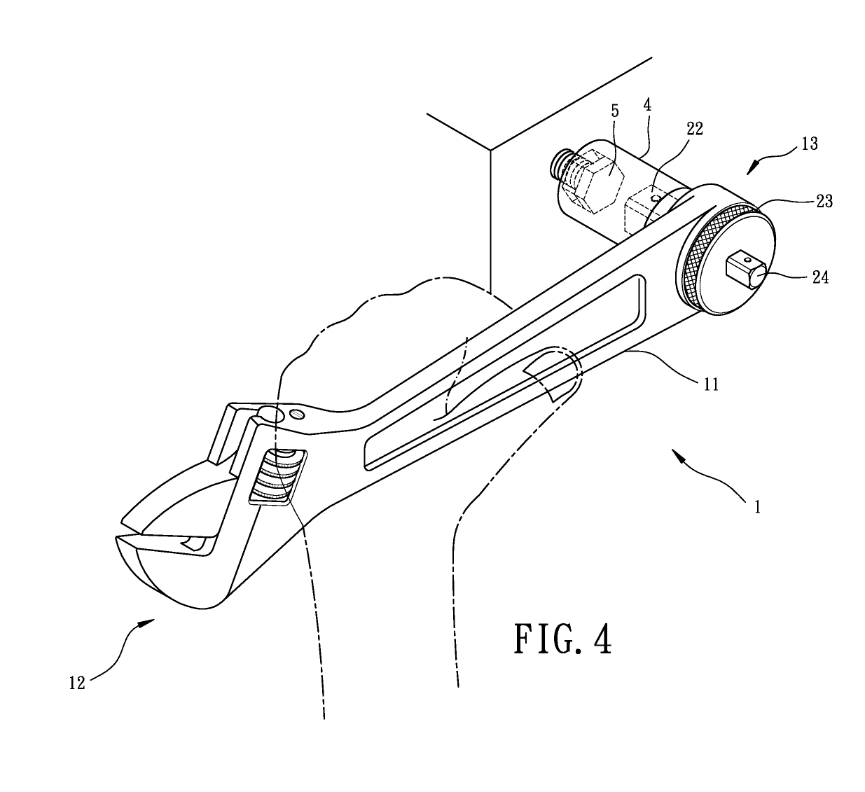

Referring to the drawings and initially to FIGS. 1-4, a hand tool (1) in accordance with the present invention comprises a shank (11) having a first end and a second end.

A first working head (12) is formed on the first end of the shank (11). The first working head (12) includes a fixed jaw (121) extending therefrom and a movable jaw (122) partially mounted in the first working head (12) and adjustably moved relative to the fixed jaw (121). A worm gear (123) is rotatably mounted in the first working head (12) for engaging with the movable jaw (122) to adjust a distance between the fixed jaw (121) and the movable jaw (122).

A second working head (13) is formed on the second end of the shank (11). The second working head (13) has a hole (131) defined therein and having an opened end and a closed end opposite to the opened end. A bore (132) is centrally defined in the closed end and communicates with the hole (131). An aperture (132) is laterally defined in an inner periphery of the hole (131) and communicates with the hole (131). A ratchet mechanism (2) is partially received in the hole (131) form the opened end of the hole (131) and having a ratchet wheel (21) entirely received in the hole (131) for providing a ratchet effect. A first driving portion (22) and a second driving portion (24) are respectively longitudinally disposed on two opposite sides of the ratchet wheel (21) and extend from two opposite sides of the second working head (13) for respectively adapting to be engaged to different workpieces. A size of the first driving portion (22) is greater than that of the second driving portion (24) for suiting different standards of workpieces. A base (221) is located between the first driving portion (22) and the ratchet wheel (21). The first driving portion (22) extends through the bore (132) and the base (221) is positioned in the bore (132) when assembling. A C-shaped ring (222) is fixed on the base (221) for rotatably fixing the base (221) in the bore (132) to prevent the ratchet wheel (21) from detaching from the hole (131). A flange (23) radially extends from a heel of the second driving portion (24). The flange (23) has an outer diameter greater than that of the ratchet wheel (21) and a series of skid-proof texture is circularly formed on an outer periphery of the flange (23) for operating the ratchet mechanism (2) in auxiliary. A restrainable mechanism (3) is mounted in the second working head (13) and comprises an elastic member (33), a ball (32) and a pawl (31). The elastic member (33) is laterally received in the aperture (132) in the inner periphery of the hole (13 1) and abuts against the ball (32). The ball (32) is pressed to flexibly abut against the pawl (31). The pawl (31) has a series of teeth formed thereon for engaging to the ratchet wheel (21).

The ratchet wheel (21) is rotatably received in the hole (131) and engaged by the pawl (31) of the restrainable mechanism (3) for ratchetably operating. A socket (4) has a first end sleeved on the first/second driving portion (22,/24) and a second end sleeved on a screw (5) when operating. A user may grasp the shank (11) of the hand tool (1) to ratchetably drive the screw (5) via the socket (4) and rotate the flange (23) for driving the socket (4) in auxiliary. Therefore, the hand tool in accordance with the present invention provides two options to operate the first working head (12) for adjustably engaging a corresponding one of different standards of workpieces, or operate the second working head (13) for ratchetably engaging to the workpiece via the socket (4).

Although the invention has been explained in relation to its preferred embodiment, it is to be understood that many other possible modifications and variations can be made without departing from the spirit and scope of the invention as hereinafter claimed.

What is claimed is:

1. A hand tool comprising:
a shank;
a first working head formed on a first end of the shank, the first working head including a fixed jaw extending therefrom, a movable jaw partially mounted in the first working head and adjustably moved relative to the fixed jaw, and a worm gear rotatably mounted in the first working head for engaging with the movable jaw to adjust a distance between the fixed jaw and the movable jaw; and
a second working head formed on a second end of the shank, a ratchet mechanism partially mounted in the second working head and including a ratchet wheel ratchetably mounted in the second working head for providing a ratchet effect, a first driving portion and a second driving portion respectively longitudinally disposed on two opposite sides of the ratchet wheel and extending from two opposite sides of the second working head for respectively adapting to be engaged to different workpieces.

2. The hand tool as claimed in claim 1 further comprising a flange radially extending from a heel of the second driving portion and having an outer diameter greater than that of the ratchet wheel.

3. The hand tool as claimed in claim 1, wherein the second working head having a hole defined therein for receiving the ratchet wheel, the hole having an opened end and a closed end opposite to the opened end, the ratchet wheel received in the hole from the opened end of the hole, a bore centrally defined in the closed end and communicating with the hole for receiving the first driving portion.

4. The hand tool as claimed in claim 3 further comprising a base disposed between first driving portion and the ratchet wheel and positioned in the bore when the ratchet wheel is received in the hole, a C-shaped ring fixed on the base for rotatably fixing the base in the bore and preventing the ratchet wheel from detaching from the hole.

5. The hand tool as claimed in claim 1, wherein the first driving portion has a size different from that of the second driving portion for suiting different standards of workpiece.

6. The hand tool as claimed in claim 1 further comprising a restrainable mechanism mounted in the second working head and having a pawl engaging to the ratchet wheel, a ball flexibly abutting against the pawl, and an elastic member compressively abutting against the ball.

7. The hand tool as claimed in claim 3, wherein the hole has an aperture laterally defined in an inner periphery thereof, a restrainable mechanism partially received in the aperture and engaging to the ratchet wheel, the restrainable mechanism comprising a pawl engaging to the ratchet wheel, a ball flexibly abutting against the pawl, and a elastic member received in the aperture and compressively abutting against the ball.
